(19) United States
(12) Patent Application Publication
(10) Pub. No.: US 2025/0348044 A1
(43) Pub. Date: Nov. 13, 2025

(54) ARTIFICIAL INTELLIGENCE SAFETY CONTROL SYSTEM FOR HAZARDOUS WORK ACTIVITIES

(71) Applicant: SAUDI ARABIAN OIL COMPANY, Dhahran (SA)

(72) Inventors: Abdulrahman A. Omair, Khobar (SA); Sultan T. Halawani, Dhahran (SA); Mazen G. Abo Shal, Dammam (SA)

(73) Assignee: SAUDI ARABIAN OIL COMPANY, Dhahran (SA)

(21) Appl. No.: 18/662,756

(22) Filed: May 13, 2024

(51) Int. Cl. G05B 13/02; G06Q 30/018

(52) U.S. Cl. CPC G05B 13/0265; G06Q 30/018

(57) ABSTRACT

A method for determining and implementing a safety control for a work activity. The method includes obtaining a work summary for a work activity to be performed in a work environment and determining, using an artificial intelligence (AI) model, a detailed work description based on the work summary, the detailed work description including one or more hazards associated with the work activity. The method further includes determining, using the AI model, a safety control to mitigate the one or more hazards, implementing the safety control and performing the work activity according to the detailed work description and the safety control.

### BACKGROUND

Numerous work activities are associated with hazards that pose a potential risks for workers or citizens living in the vicinity of the work environment. Due to these hazards, work activities often require obtaining a work permit from regulating authorities. In many situations, obtaining and maintaining the work permit depends on whether suitable safety controls remain properly implemented to mitigate the associated hazards.

Generally, detecting potential hazards, determining safety controls, requesting and issuing work permits constitute a complex process involving multiple parties who may be adversarial in nature. Properly implemented, multimodal artificial intelligence may offer potential solutions to automatize some of the main steps of the process and facilitate the communication between the different parties.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for determining and implementing a safety control for a work activity. The method includes obtaining a work summary for a work activity to be performed in a work environment and determining, using an artificial intelligence (AI) model, a detailed work description based on the work summary, the detailed work description including one or more hazards associated with the work activity. The method further includes determining, using the AI model, a safety control to mitigate the one or more hazards, implementing the safety control and performing the work activity according to the detailed work description and the safety control.

In one aspect, embodiments disclosed herein relate to a system for determining and implementing a safety control for a work activity. The system includes a work environment and a computer. The computer includes one or more computer processors and is configured to receive a work summary for a work activity to be performed in the work environment and determine, using an artificial intelligence (AI) model, a detailed work description based on the work summary, the detailed work description including one or more hazards associated with the work activity. The computer is further configured to determine, using the AI model, a safety control to mitigate the one or more hazards. The system further includes a safety control system, structured to receive the safety control from the computer, and implement the safety control. The system further includes a work entity, connected to the computer and the safety control system, the work entity structured to perform the work activity according to the detailed work description and the safety control.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1A depicts a construction site, in accordance with one or more embodiments disclosed herein.

FIG. 1B depicts a processing plant, in accordance with one or more embodiments disclosed herein.

FIG. 1C depicts a well drilling site, in accordance with one or more embodiments disclosed herein.

FIG. 1D depicts a well production site, in accordance with one or more embodiments disclosed herein.

FIG. 2 depicts a system for implementing a safety control and monitoring safety compliance of a work activity, in accordance with one or more embodiments disclosed herein.

FIG. 3 depicts a system for sending a work authorization request and issuing a work authorization, in accordance with one or more embodiments disclosed herein.

FIG. 4 depicts an artificial intelligence-assisted work authorization system, in accordance with one or more embodiments disclosed herein.

FIG. 5 depicts a flowchart of a method for determining and implementing a safety control to mitigate hazards associated with a work activity, in accordance with one or more embodiments disclosed herein.

FIG. 6 depicts a flow chart of a method for issuing a work authorization for a work activity and monitoring safety of the activity, in accordance with one or more embodiments disclosed herein.

FIG. 7 depicts an example diagram of a neural network, in accordance with one or more embodiments disclosed herein.

FIG. 8 depicts an example diagram of a computer, in accordance with one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a computer may reference two or more such computers.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Terms such as “approximately,” “about,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, these terms may mean that there can be a variance in value of up to +10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

It is to be understood that one or more of the steps shown in a flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

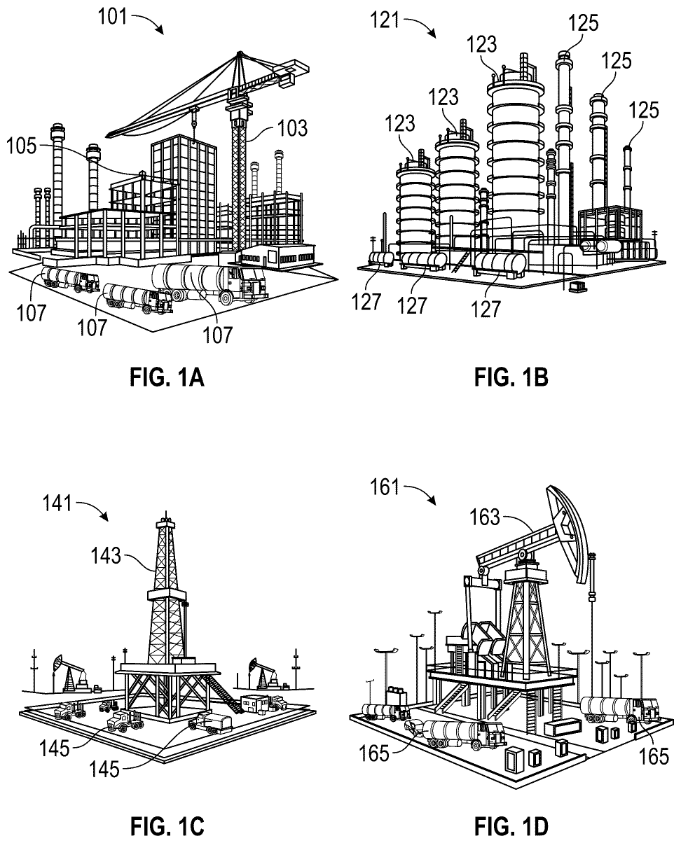

In the following description of FIGS. 1A-8, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Methods and systems are disclosed for determining, using artificial intelligence, safety controls to mitigate hazards associated with a work activity. Furthermore, methods and systems are disclosed for requesting and issuing, automatically, a work authorization, among other uses. Furthermore, methods and systems are disclosed for monitoring safety of a work activity, among other uses.

Generally, embodiments in this disclosure relate to work activities, where work activities can be of many types. Work activities may be categorized by various systems. For instance, work activities may be categorized according to sectors. In some classifications, work activities are partitioned into three sectors, namely, a primary, secondary and tertiary sector. The primary sector encompasses work activities involved in extracting or harvesting raw materials. Work activities in the primary sector include agriculture, fishing, forestry, and mining. Work activities in the secondary sector include transforming these raw materials into finished or semi-finished goods through manufacturing and processing. In some classifications, work activities in the secondary sector include automobile manufacturing, food processing, and textile production. The tertiary sector includes service-oriented work activities that support consumers and organizations. Examples of work activities in the tertiary sector include retail, transportation, banking, healthcare, education, and entertainment. Generally, work activities aim to produce and distribute goods, services, or both.

Work activities occur in a work environment. Work environments may be of various types, depending on the work activities performed in the work environment. The systems and methods in this disclosure are not specific to any particular work activity or work environment. FIGS. 1A-1D show example work environments. FIG. 1A depicts a construction site (101). Construction sites may be configured in a myriad of ways. Therefore, the construction site (101) is not intended to be limiting with respect to the particular configuration in FIG. 1A. The construction site (101) includes a crane (103), a building (105) under construction and a first plurality of trucks (107). The construction site (101) may include other components not depicted in FIG. 1A, such as construction materials, tools and workers. Construction sites may further include more than one crane and more than one building or structure under construction. Construction sites may further include equipment and structures not depicted in FIG. 1A. Examples of work activities that may be performed on the construction site (101) include, but are not limited to, excavating, masonry, carpentry, electrical work, plumbing, roof installation, operating heavy machinery, construction planning, transportation and logistics.

FIG. 1B depicts a processing plant (121). Processing plants may be configured in a myriad of ways. Therefore, the processing plant (121) is not intended to be limiting with respect to the particular configuration in FIG. 1B. The processing plant (121) includes a plurality of gas sweeteners (123), a plurality of fractionation towers (125) and a plurality of sulfur recovery units (127). The processing plant (121) may include other components not depicted in FIG. 1A, such as storage tanks, heat exchangers, accumulators, boilers, pumps, inlet separators, coolers, evaporators, plant sensors, plant instruments, gauges, control switches, valves, emergency stop controls, pressure relief equipment, flaring equipment, smoke detectors, toxic gas detectors, thermal detectors, combustible gas detectors, electric power generators, turbines, exhaust fans, light panels, fume scrubbers, safety showers. Processing plants may further include a different number of gas sweeteners, fractionation towers or sulfur recovery units from the ones in FIG. 1B. Processing plants may further include other equipment and structures not depicted in FIG. 1B. Examples of work activities that may be performed at the processing plant (121) include, but are not limited to, designing a process flow for the processing plant, engineering operating a processing unit, managing material flow rates, electrical work, chemical work, operating heavy machinery, planning, transportation and logistics.

FIG. 1C depicts a well drilling site (141). Well drilling sites may be configured in a myriad of ways. Therefore, the well drilling site (141) is not intended to be limiting with respect to the particular configuration in FIG. 1C. The well drilling site (141) includes a derrick (143) and a second plurality of trucks (145). The well drilling site (141) may include other components not depicted in FIG. 1C, such as a pump, a tank, a mud pit, a drill string, a wellbore, a casing and sensors. Well drilling sites may further include more than one derrick. Well drilling sites may further include other equipment and structures not depicted in FIG. 1C. Examples of work activities that may be performed on the well drilling site (141) include but are not limited to, assembling the derrick, operating a drill string, operating a mud flow, fracking, optimizing a drilling rate, cementing, installing a casing, maintenance or repair, operating heavy machinery, well planning, transportation and logistics.

FIG. 1D depicts a well production site (161). Well production sites may be configured in a myriad of ways. Therefore, the well production site (161) is not intended to be limiting with respect to the particular configuration in FIG. 1D. The well production site (161) includes a pumpjack (163) and a third plurality of trucks (165). The well production site (161) may include other components not depicted in FIG. 1D, such as valves, a gas-lift system, a tank, a wellbore, a casing and sensors. Well drilling sites may further include more than one pumpjack. Well drilling sites may further include other equipment and structures not depicted in FIG. 1D. Examples of work activities that may be performed on the well production site (161) include but are not limited to, operating the pumpjack, monitoring production fluid flow rates, cementing, installing a casing, acidizing, a cleanout, maintenance or repair, operating heavy machinery, well planning, transportation and logistics.

In some embodiments, a work activity entails one or more hazards that may pose a risk to a workers, the work environment or a vicinity of the work environment. Examples of hazards associated with a work activity include physical hazards, such as moving machinery, a slippery floor, noise, vibration, a high temperature, an electrical hazard, a fall from heights, a confined space, a fire and a poorly ergonomic position. Risks associated with physical hazards include an injury or a musculoskeletal disorder. Examples of hazards associated with a work activity further include chemical hazards, such as an exposure to a toxic chemical, a gas, fumes, dust, a solvent and a corrosive material. Risks associated with chemical hazards include a skin irritation, a respiratory problem, a chemical burn and an intoxication. Examples of hazards associated with a work activity further include biological hazards, such as exposure to a virus, a bacterium, a fungus, a parasite and an allergen. Risks associated with biological hazards include an illness and a life-threatening health condition. Examples of hazards associated with a work activity further include environmental hazards, such as an exposure to a radiation, an extreme weather condition, air pollution and a natural disaster. In some embodiments, environmental hazards extend away from the environment where the work activity is performed. Examples of hazards associated with a work activity further include psychosocial hazards, such as workplace stress, harassment, bullying and violence in the work environment. Risks associated with psychosocial hazards include an injury, a degradation of mental health and a deterioration of well-being. It is emphasized that the hazards described herein are given only as examples and should be considered non-limiting. One with ordinary skill in the art will readily appreciate that the other hazards may be used as examples without departing from the scope of this disclosure.

In one or more embodiments, a hazard is mitigated by using a safety control. In this disclosure, a safety control is defined as a set of one or more safety features. Thus, although the terms “safety control” is singular, the safety control may include one or a plurality of safety features. The safety features are divided into two categories: pre-deployable safety before the work activity begins. A post-deployable safety feature is deployed after the work activity begins or exactly when the work activity begins. In other words, post-deployable safety features are deployed in response to commencement of the work activity. Implementing the safety control includes deploying the pre-deployable safety features and scheduling to deploy the post-deployable safety features. Examples of pre-deployable safety features include affixed safety devices, preparatory safety training, preparatory safety communication and safety investigation. Examples of post-deployable safety features include unfixed safety devices, safety agendas and continuous safety training.

Examples of affixed safety devices include fixtures and removable items attached to the work environment, such as a machine guard, a handrail, a barrier, a ventilation system, a fire extinguisher, a first aid kit disposed in the work environment, a communication system, an ergonomic office workstation and a physical evacuation map hung in the work environment. Examples of unfixed safety devices include protective gears, equipment and accessories used by workers in the work environment, such as a helmet, goggles, gloves, a respiratory mask, a hearing protection and a harness. Examples of safety agendas include job rotation, safety committee meetings, signage, emergency response plans, fire evacuation plans, safety inspections and audits. Examples of safety training include hazard awareness training, education to safe work practices, emergency procedures training, emergency drills, and training for specific tasks or equipment based on the work activity. Safety training performed before the work activity begins is called preparatory safety training. Safety training performed after or exactly when the work activity begins is called continuous safety training. Examples of preparatory safety communications include a mail, or electronic mail, sent to workers, that includes a list of safety rules, safety regulations, an evacuation plan, a map of the work environment or a handbook. Examples of safety investigations include an analysis of incidents that have occurred in the past for similar work activities or in similar work environments. It is emphasized that the safety features described herein are given only as examples and should be considered non-limiting. One with ordinary skill in the art will readily appreciate that the other safety features may be used without departing from the scope of this disclosure.

Table I displays examples of work activities, hazards associated with the work activities and safety features designed to mitigate the hazards. In Table I, a first column features a list of work activities. In a second column, one or more hazards are associated with each work activity from the first column. In a third column, one or more safety features is proposed for each hazard from the second column. A safety control for a work activity is the set of all safety features for a work activity. For instance, for the “install light on a roof” work activity in Table I, “wear a harness” is a safety feature for the “fall from height” hazard. The safety features “wear protective gloves” and “turn off electrical power throughout the work” are safety features for the hazard “Electrocution”. The sequence “wear a harness”, “wear protective gloves”, “turn off electrical power throughout the work”, “install fire detectors” and “install fire extinguishers” is a safety control for the work activity “install light on a roof”.

TABLE I
Example work activities, associated hazards
and associated safety features.

| Work activity | Hazard | Safety feature |
|---|---|---|
| Install light on a roof | Fall from heights | Wear a harness |
| | Electrocution | Wear protective gloves |
| | | Turn off electrical power |
| | | throughout the work |
| | Fire | Install fire detectors |
| | | Install fire extinguishers |
| Repairing a sulfur | Exposure to | Wear protective outfit |
| recovery unit | sulfuric acid | Wear respiratory mask |
| Performing maintenance | Fall from heights | Wear a harness |
| on a flare pit | Fire | Wear fire resistant clothing |
| | | Attend fire safety training |
| Acidizing a borehole | Exposure to acid | Wear protective outfit |
| | | Wear respiratory mask |
| | Moving | Wear Helmet |
| | machinery | Attend machine specific |
| | | training |
| Office work | Ergonomic | Conduct ergonomic |
| | position | assessment |
| | | Purchase ergonomic chairs |
| | | and desks |
| Transport construction | Road accident | Attend driving course |
| material | Fatigue | Implement shift rotation |
| | Lift heavy load | Purchase loading |
| | | equipment |
| | | Attend specific safety |
| | | training |

Owing to the risk originating from associated hazards, some work activities require a work authorization prior to being performed. Work authorizations may be of various types, depending on the hazards associated with the work activity. Generally, a work authorization is issued, for a work activity, by a regulatory entity such as a governmental agency responsible for safety in work environments, or a private entity responsible for enforcing safety regulations. In the context of this disclosure, an entity in charge of issuing a work authorization is referred to as an issuer. In some embodiments, the issuer is part of a safety enforcement system. In addition to issuing work authorizations, the safety enforcement system is structured to perform one or more other tasks, such as, for example, designing safety regulations, inspecting work environments and imposing fines on safety violators. In some embodiments, a requirement for issuing a work authorization for a work activity involving hazards is that a safety control be implemented to mitigate the hazards. Examples of work authorizations include a work permit. A work permit is an official document designed to convey that the work activity is authorized. In some embodiments, the work permit is a written document. In some embodiments, the work permit is written in a pre-defined format. In some embodiments, the work permit is a legal document, written by the regulatory entity. Examples of hazards and associated work permits are displayed in Table II.

TABLE II
Example work activities, associated
hazards and associated work permits.

| Work activity | Hazard | Work permit |
|---|---|---|
| Soldering | Exposure to heat | Hot work |
| | Fire | |
| Cleaning the inside of a | Suffocation | Confined space |
| tank | | |
| Installing electrical | Electrocution | Electrical work |
| wiring in a wall | Fire | |
| Repairing a roof | Fall from height | Working at height |

In accordance with some embodiments, several stages are required before a work activity commences, including defining the work activity, determining hazards associated with the work activity, determining a safety control to mitigate the hazards, implementing the safety control, verifying that the safety control is properly implemented, requesting a work authorization, communicating with the issuer and receiving the work authorization. In some embodiment, safety is monitored while the work activity is being performed and remediations are imposed in case the safety does not meet pre-defined safety standards. In accordance with some embodiments, the stages are required before and after a work activity commences involves multiple parties, such as a client organization that needs the work activity to be performed, a work entity performing the work activity, a requester who requests a work authorization for the work activity, an issuer who decides whether the work authorization is granted and issues the work authorization, a regulator who provides safety regulations and safety control system who implements the safety control. Relationships between the multiple parties may be collaborative or adversarial. In some embodiments, some parties within the multiple parties are associated in a same organization. For instance, in some embodiments, the client organization, the work entity, the requester and the safety control system are part of a same work organization. In some embodiments, the issuer and the regulator are part of a same safety enforcement system. In some embodiments, parties within the work organization have a collaborative relationship, parties within the safety enforcement system have a collaborative relationship, and parties among the work organization have an adversarial relationship with parties among the safety enforcement system.

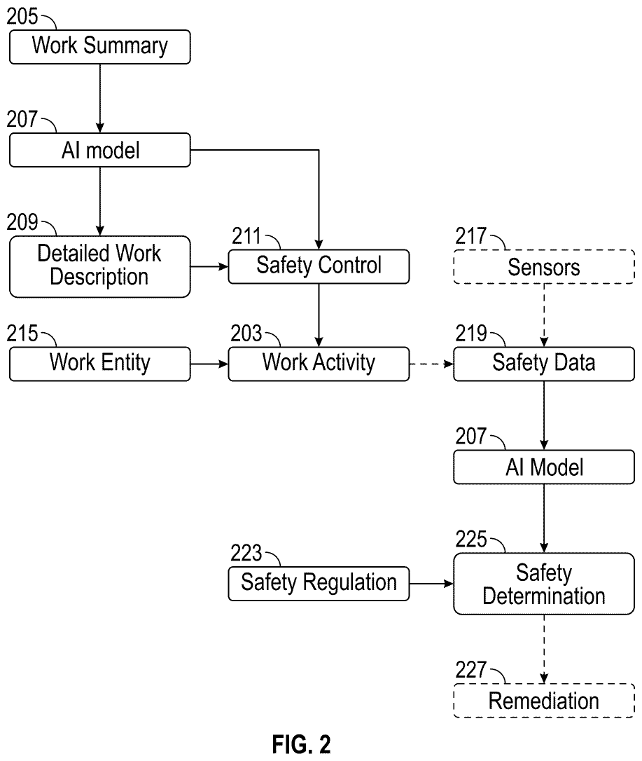

FIG. 2 depicts a system for selecting and implementing a safety control to mitigate hazards associated a work activity. The system in FIG. 2 further includes components for monitoring safety compliance of a work activity. As depicted in FIG. 2, a work summary (205) is obtained for a work activity (203) to be performed for a work organization. The work summary (205) can be of various types. In one more embodiments, the work summary (205) includes one or more of a short textual description of the work activity (203), a name for the work activity (203), an environment where the work activity (203) is to be performed, and a location where the work activity (203) is to be performed. The short textual description may be defined as a text composed of at most a certain pre-defined number of words, such as 20 words. The work organization may be of many types, including, a for-profit company, a non-profit company, a governmental organization, a partnership and a sole proprietorship. The work organization may include one or more departments, such as an engineering department, a human resource department, a service department, a mechanical department, a legal department, a sales department, a research and development department and a Health, Safety and Environment (HSE) department. In some embodiments, the work organization extracts, processes, sells, or performs any combination of extracting, processing and selling a raw material, such as a hydrocarbon. In some embodiments, the work organization sells manufactured products, product, such as cars, textile products and furniture. In some embodiments, the work organization constructs and sells structures, such as buildings, roads and bridges. In some embodiments, the work organization sells a service, such as housing, transportation, insurance, and financial services. Those skilled in the art will appreciate that the work organizations described herein are intended to serve as examples only. The systems and methods in this disclosure apply to any work organization conducting work activities presenting a hazard.

In some embodiments, the work summary (205) is defined by a requester. The requester may be an individual, a plurality of individuals, or a machine capable of defining the work summary (205). The requester is capable of generating a text. In some embodiments, the requester makes use of artificial intelligence (AI). Also, in some embodiments, the requester is part of the work organization. In other embodiments, the requester is contracted by the work organization. An artificial intelligence (AI) model (207) receives the work summary (205) as input and returns, as output, a detailed work description (209) of the work activity (203). The detailed work description (209) includes, at least, one or more hazards associated with the work activity. Examples of hazards for work activities are described in Tables I and II. The format of the one or more hazards in the detailed work description (209) may be of many types. Examples of formats for the one or more hazards include but are not limited to, a name of each hazard among the one or more hazards, a textual description of each hazard among the one or more hazards and an encoding of each hazard among the one or more hazards, the encoding defined as an ordinal label (which may be numeric) or, for example, a one-hot encoding label or vector. In order to create an encoding of each hazard among the one or more hazards, the one or more hazards must be selected from a pre-defined hazard list. Each hazard among the pre-defined hazard list is assigned a number. Then, each hazard among the one or more hazards is encoded as the corresponding number from the pre-defined hazard list. That is, in one or more embodiments, the AI model (207) generates a detailed work description (209) including at least a list of identified hazards based on a received work summary (205).

In addition to the one or more hazards, the detailed work description (209) may include other components. Examples of other components that may be included in the detailed work description (209) include a hazard type for each of the one or more hazards, such as a physical hazard, a chemical hazard, a biological hazard and a psychosocial hazard. Examples of other components that may be included in the detailed work description (209) further include a personal injury score for each of the one or more hazards. For instance, a personal injury score may be defined as “extreme”, “strong”, “medium” or “weak”, according to the severity of an accident that may be caused by the hazard. In one or more embodiments, a personal injury is scored as “extreme” if the accident may cause a fatality; a personal injury is scored as “strong” if the accident may cause a severe injury; a personal injury is scored as “medium” if the accident may cause a minor injury; a personal injury is scored as “weak” if the harm caused by the accident does not result in an injury. In other embodiments, the personal injury score is a numerical value within a range, with higher values of the range representing higher severities. For instance, a personal injury score may be defined as any real number in the interval [0,10], with 0 representing a weak personal injury and 10 representing an extreme personal injury. Examples of other components that may be included in the detailed work description (209) further include an economical impact score for each of the one or more hazards. In some implementations, the economical impact score of a hazard is an amount of revenue loss resulting from an accident that may be caused by the hazard.

Examples of components that may be included in the detailed work description (209) further include an accident probability for each of the one or more hazards, defined as a probability that an accident may happen as a consequence of the hazard. In some implementations, the accident probability for a hazard is determined from an accident database. The database includes occurrences of the hazard in past work activities and an indicator whether or not an accident happened for each occurrence. Then, in some implementations, the accident probability for a hazard is defined as the number, from the accident database, of occurrences of an accident due to the hazard divided by the number, from the accident database, of occurrences of the hazard. Examples of components that may be included in the detailed work description (209) further include an expected loss. In some implementations, the expected loss is an expected personal loss, defined as a product of the accident probability and the personal injury score. In some implementations, the expected loss is an expected economical loss, defined as a product of the accident probability and the economical impact score. In some implementations, the expected loss is a combination of the expected personal loss and the expected economical loss.

Examples of components that may be included in the detailed work description (209) further include a detailed textual description of the work activity (203). The detailed textual description is longer and includes more information than the work summary (205). Examples of components that may be included in the detailed work description (209) further include a hazard map for the work activity (203). In some embodiments, the hazard map includes a location of each of the one or more hazards. Examples of components that may be included in the detailed work description (209) further include one or more of a time frame for the work activity (203), a Gantt chart for the work activity (203), an equipment required to perform the work activity (203), and one or more resources required by the work activity (203). Any textual description included in the detailed work description (209), such as the textual description of the work activity (203), may be a generated text, or a categorical text. In some implementations, the textual description of the work activity (203) is a generated text. In such implementations, the AI model (207) may include a natural language processing (NLP) model configured to extract key words from the work summary (205) and generate the textual description of the work activity (203), based on the key words. In some implementations, the textual description of the work activity (203) is a categorical text. A plurality of textual descriptions is pre-defined and the AI model (207) classifies, rather than generates, the textual description among the plurality of textual descriptions.

Generally, the detailed work description (209) includes one or more categories, one or more real numbers, one or more generated texts, or any combination thereof. The AI model (207) may be of various types. The AI model (207) is a multimodal model configured to perform a plurality of tasks. The AI model (207) includes a plurality of components, each component being configured to perform a task within the plurality of tasks. It is noted that each component of the AI model (207) may itself include one or more AI algorithms, which may be based on machine learning networks. A first task of the AI model (207) is the determination of the detailed work description (209). The first task is performed by a first component of the AI model (207). In one or more embodiments, the input work summary (205) is a text and the first component of the AI model (207) includes a natural language processing model. The first component of the AI model (207) may be configured in several ways, depending on the format of the output detailed work description (209). The first component of the AI model (207) may include one or more classification models, one or more regression models, one or more text generators, or any combination thereof that predict, respectively, the one or more categorical variables, one or more real numbers, one or more generated texts or any combination thereof that compose the detailed work description (209). The architecture of the first component of the AI model (207) may be of several types. As non-limiting examples, the first component of the AI model (207) may include a neural network, such as a fully connected neural network, a convolutional neural network, a recurrent neural network (RNN), a long short term memory (LSTM) network, a gated recurrent unit (GRU), a transformers model, or any combination of fully connected, convolutional, pooling, recurrent, LSTM, GRU, or normalization layers. The first component of the AI model (207) may include other structures outside of the ones described herein without departing from the scope of this disclosure.

Continuing with FIG. 2, a second component of the AI model (207) receives, as input, the detailed work description (209) and returns, as output, a safety control (211) to mitigate the one or more hazards in the detailed work description (209). The safety control (211) includes one or more safety features. Examples of safety features are listed in Table I. The safety control (211), as output by the second component of the AI model (207), may be of several formats. The safety control (211) may include a list of names of the one or more safety features composing the safety control (211), a textual description of each of the one or more safety features, a suggested equipment to implement the safety control, a time frame for the safety control, a cost of implementing the safety control, one or more images of the safety control, a resource required to implement the safety control, such a human resource, a machine, a material and a computer. The second component of the AI model (207) may include one or more classification models, one or more regression models, one or more text generators, one or more image generators, or any combination thereof.

The safety control (211) is implemented. As previously described, implementing the safety control includes deploying the pre-deployable safety features and scheduling to deploy the post-deployable safety features. In that regard, examples of steps of the implementation of the safety control (211) are described herein. In some embodiments, the safety control includes an affixed safety device such as a machine guard, a handrail, a barrier, a ventilation system or a fire extinguisher. In such embodiments, implementing the safety control (211) includes installing the affixed safety device in the work environment. In some embodiments, the safety control includes preparatory safety training such as hazard awareness training, education to safe work practices and emergency procedures training. In such embodiments, implementing the safety control (211) includes conducting the preparatory safety training to workers who are to perform the work activity. In some embodiments, the safety control includes preparatory safety communication, such as an electronic mail that includes a list of safety rules, safety regulations, an evacuation plan, or any combination thereof. In such embodiments, implementing the safety control (211) includes sending the electronic mail to workers who are to perform the work activity. In some embodiments, the safety control (211) includes protective gear to be used by workers to perform the work activity, such as a helmet, goggles, gloves, a respiratory mask, a hearing protection and a harness. Such unfixed devices are to be work during the work activity, rather than before the work activity. In such embodiments, implementing the safety control (211) includes planning for the workers to use the protective gear. In such embodiments, implementing the safety control (211) further include purchasing enough protective gear for the workers to use when the work activity is being performed. In some embodiments, the safety control (211) includes a safety agenda, such as job rotation and safety committee meetings. In such embodiments, implementing the safety control (211) includes scheduling the safety agenda. In some embodiments, implementing the safety control (211) further includes documenting, with a written text or an electronic file, that a post-deployable safety feature is scheduled to be deployed.

The safety control (211) is implemented by a safety control system. In some embodiments, the safety control system and the requester belong to the same organization. In some embodiments, the safety control system receives a command to implement the safety control (211) from the requester. In some embodiments, the safety control system is part of the work organization. The safety control system may be of various types, depending on the safety control (211). In one or more embodiments, the safety control system includes a maintenance system. The maintenance system includes equipment, tools and one or more workers who are able to install affixed safety devices. In some embodiments, the safety control system includes a training protocol to conduct safety training for workers. The training protocol includes a safety training course. The training protocol may further include a training facility, one or more instructors and one or more computers. In some embodiments, the safety control system includes personnel or a machine structured to send safety information to workers, such as an emergency plan. In some embodiments, the safety control system includes a transport and logistics department configured to purchase, rent, and order delivery of safety devices to the work environment, the safety devices including affixed or unfixed safety devices, or both. In one or more embodiments, the safety control system makes use of AI. It is emphasized that the components of safety control systems described herein are given only as examples and should be considered non-limiting. One with ordinary skill in the art will readily appreciate that the safety control system may be configured differently without departing from the scope of this disclosure.

The work activity (203) is performed by a work entity (215). The work activity (203) is performed in accordance with the detailed work description (209) and the safety control (211). Thus, in some embodiments, the post-deployable safety features are deployed while the work activity (203) is being performed. For instance, if the post-deployable safety features include a requirement that the workers wear a protective gear, the workers wear the protective gear while performing the work activity. In some embodiments, the work entity (215) includes one or more individuals performing the work. In some embodiments, the work entity (215) includes one or more departments, such as a maintenance department, a human resource department and an engineering department. In some embodiments, the work entity (215) and the requester are part of a same organization. In some embodiments, the work entity (215) is part of the work organization.

While the work activity (203) is being performed, a safety assessment is performed to verify that the work activity (203), that follows the safety control (211), conforms to a safety regulation (223). In some embodiments, the safety assessment is made by a third party from the work organization. The safety assessment includes at least two steps: obtaining safety data (219) and making a safety determination (225) whether the work activity (203) conforms to the safety regulation (223). In that regard, safety data (219) is obtained for the work activity (203). The safety data (219) is indicative of a state of the work activity (203). The safety data (219) can be of many types. The safety data (219) may include one or more components including, as non-limiting examples, an image of the work environment, a video of the work environment, a sound recorded in the work environment, a temperature of the work environment, a pressure of the work environment and a level of a toxic gas in the work environment. The safety data (219) may further include personal data of workers performing the work activity, such as, for each worker, an age, a physical condition, a medical record and a psychological assessment. The safety data (219) may further include a record that a training program was completed by the workers. The safety data (219) may further include a mail or electronic mail containing an evacuation plan, sent to workers performing the work activity (203). In one or more embodiments, some components of the safety data (219) is captured using one or more sensors (217), installed in the work environment. The one or more sensors (217) can be of many types. Example of sensors that can be used as the one or more sensors (217) include, but are not limited to, a camera, a gas detector, a thermometer, a microphone and a barometer. In implementations where the one or more sensors (217) include a camera, the safety data (219) includes an image or video of the work environment.

The AI model (207) includes a third component configured to receive the safety data (219) as input and return, as output, a safety state of the work activity (203). As seen in FIG. 2, the AI model (207) can be used at different portions of the depicted workflow in accordance with one or more embodiments. The safety state can be used, read or interpreted to make a safety determination (225) whether the work activity (203) conforms to the safety regulation (223). The safety regulation (223) is obtained from a regulator. The safety regulation (223) includes conditions for the work activity (203) to be considered as safe. The safety regulation (223) may be of several types and include one or more components. In some implementations, the safety regulation includes a textual definition of a safe work environment for the work activity (203). In some implementations, the safety regulation (223) imposes that a pre-deployable safety feature, a post-deployable safety features, or both be deployed for the work activity (203). For instance, in some embodiments, the safety regulation (223) includes a requirement that a given affixed safety device be installed, such as a machine guard, a handrail, a barrier, a ventilation system, a fire extinguisher, a first aid kit, an ergonomic office workstation and an evacuation map of the work environment. In some implementations, the safety regulation (223) includes a safety guideline. A safety guideline is defined as a set of rules that must be followed for the work activity (203) to be considered as safe. In scenarios where the work activity (203) is not hazardous, the safety regulation (223) may include a tag saying that the work activity (203) is not hazardous. In some embodiments, the safety regulation (223) requires that the pre-deployable safety features and the post-deployable safety features be deployed.

As stated, in some implementations, the safety regulation (223) requires that a safety device be installed in the work environment, such as a machine guard, a handrail, a barrier, a ventilation system, a fire extinguisher, a first aid kit, an ergonomic office workstation and an evacuation map of the work environment. In some implementations, the safety regulation (223) further requires that the safety device be installed according to an installation rule. Examples of installation rules for the safety device include that the safety device be installed at a specific location, or within a pre-defined radius of the specific location in the work environment. For instance, if the safety device is a fire extinguisher, the installation rule may be defined as the fire extinguisher being installed less than three meters of a flame. Examples of installation rules for the safety device further include that the safety device be installed at a specific height, or within a pre-defined radius of the specific height in the work environment. For instance, if the safety device is an evacuation map of the work environment, the installation rule may be defined as the evacuation map being installed on a wall, at a height between four and six feet. Examples of installation rules for the safety device further include that the safety device be of a specific size. For instance, if the safety device is a barrier, the installation rule may be defined as the barrier being at least two meter tall. In some implementations, the safety regulation (223) further requires that the safety device follows a safety guideline. For instance, in some implementations, the safety device is an evacuation map and the safety regulation (223) further includes a requirement that the evacuation map include a muster point and an organizer, the organizer trained to guide workers from a working location to the muster point. It is emphasized that the components of the safety regulation (223) described herein are given only as examples and should be considered non-limiting. One with ordinary skill in the art will readily appreciate that the safety regulation (223) may be structured differently without departing from the scope of this disclosure.

The regulator is part of a regulatory entity, such as a governmental agency responsible for safety in work environments, or a private entity in charge of enforcing safety regulations. The regulator may be an individual, a plurality of individuals or a machine.

The safety state may be of several types. While a full description of any possible formats for the safety state extends beyond the scope of this disclosure, some examples of components of the safety state are described herein for illustration purposes. Generally, the safety state includes one or more categorical or numerical indicators. In some embodiments, the safety state includes a binary indicator equal to “true” if the work activity (203) conforms to the safety regulation (223) and “false” if the work activity (203) does not conform to the safety regulation (223). In some embodiments, the safety regulation (223) includes a plurality of components and the safety state includes, for each component of the safety regulation (223), a binary indicator equal to “true” if the work activity (203) conforms to the component of the safety regulation (223) and “false” if the work activity (203) does not conform to the component of the safety regulation (223). For instance, in some scenarios, the safety regulation (223) requires that an evacuation map and a fire extinguisher be installed in the work environment and the safety state includes a first binary indicator equal to “true” if the evacuation map is installed in the work environment or “false” if no evacuation map is installed in the work environment. The safety state further includes a second binary indicator equal to “true” if the fire extinguisher is installed in the work environment and “false” if no fire extinguisher is installed in the work environment. In some embodiments, the safety regulation (223) requires that the pre-deployable safety features and the post-deployable safety features be deployed. In such embodiments, the safety state may include, for each pre-deployable safety feature and each post-deployable safety feature, a binary indicator indicating whether the safety feature is deployed.

Generally, if the safety regulation (223) requires that a safety device be installed in the work environment, the safety state may include a binary indicator related to the safety device, equal to “true” if the safety device is installed in the work environment, or “false” is no safety device is installed in the work environment. If the safety regulation (223) includes a requirement that a safety device be installed in the work environment, and that the safety device be installed according to an installation rule, the safety state may include two indicators related to the safety device. A first binary indicator, related to the safety device, is equal to “true” if the safety device is installed in the work environment, or “false” is no safety device is installed in the work environment. A second binary indicator is equal to “true” if the safety device is installed according to the installation rule, or “false” if the safety device is not installed according to the installation rule. In some embodiments the safety device is a fire extinguisher and the installation rule is defined as the fire extinguisher being installed less than three meters from a flame. In this example, three mutually exclusive scenarios may occur. In a first scenario, the fire extinguisher is not installed in the work environment; the first binary indicator is 0 and the second binary indicator is 0. In a second scenario, the fire extinguisher is installed in the work environment, at most three meters from the flame; the first binary indicator is 1 and the second binary indicator is 1. In a third scenario, the fire extinguisher is installed in the work environment, more than three meters from the flame; the first binary indicator is 1 and the second binary indicator is 0.

If the safety regulation (223) includes a requirement that a safety device be installed in the work environment, and that the safety device follow a safety guideline, the safety state may include two binary indicators related to the safety device. A first binary indicator, related to the safety device, is equal to “true” if the safety device is installed in the work environment, or “false” is no safety device is installed in the work environment. A second binary indicator is equal to “true” if the safety device follows the safety guideline, or “false” if the safety device does not follow the safety guideline. In some embodiments, the safety device is an evacuation map and the safety guideline is that the evacuation map include a muster point. In this example, three mutually exclusive scenarios may occur. In a first scenario, the evacuation map is not installed in the work environment; the first binary indicator is 0 and the second binary indicator is 0. In a second scenario, the evacuation map is installed in the work environment and includes a muster point; the first binary indicator is 1 and the second binary indicator is 1. In a third scenario, the evacuation map is installed in the work environment but does not include a muster point; the first binary indicator is 1 and the second binary indicator is 0.

In some embodiments, the safety state includes one or more indicators having a floating format, rather than a Boolean, “true” or “false” status. In such scenarios, each indicator indicates a score for the work activity (203) at fulfilling a component of the safety regulation (223). In some implementations, each score lies between 0 and 1. For any component of the safety regulation (223), three situations, namely a), b), or c) may occur: a) the score is equal to zero if the component is ignored by the work activity (203); b) the score is equal to 1 if the work activity (203) fulfills the component entirely; c) the score is between 0 and 1 if the work activity (203) fulfills the component partially. In one or more embodiments, the score for any component of the safety regulation (223) is an average of Boolean indicators related to the component in the safety state. For instance, in a previously described example, the safety state includes two Boolean indicators for a requirement, from the safety regulation (223), that a safety device be installed in the work environment according to an installation rule. Then, in accordance with some embodiments, the score for the safety device being installed in the work environment according to the installation rule is an arithmetic average of the two Boolean indicators.

In some embodiments, the safety regulation (223) includes one or more safety devices to be installed in the work environment and further includes, for each safety device, a specific location at which the safety device must be installed. In such embodiments, the safety state may include a map of the work environment and one or more indicators for the safety devices on the map. The one or more indicators may be configured in many ways. In some implementations, the one or more indicators includes one indicator for each safety device. For a given safety device, the indicator is defined as a pair composed of a score and a circular box with a certain color. The circular box is centered at a specific location at which the safety device is required to be installed as per the safety regulation (223). In some implementations, the color of the box is green if the given safety device is installed within the box, and red if the given safety device is not installed within the box. The score indicates how close to the specific location the given safety device is installed. In some implementations, the score is equal to

$$1 - \frac{P - C}{R}$$

if the box is green, where P stands for the position where the given safety device is installed, C denotes the center of the box and R denotes a radius of the box. The score is equal to 0 if the box is red. Note that in such scenarios, the score is equal to 1 if the given safety device is installed at the center of the box (i.e.: at the exact given position). It is emphasized that the formats of the safety state described herein are given only as examples and should be considered non-limiting. One with ordinary skill in the art will readily appreciate that the safety state may be of different formats, or include different components not described without departing from the scope of this disclosure.

The third component of the AI model (207) may be of several types, depending on the format of the safety state. In some embodiments, the third component of the AI model (207) includes a NLP model configured to interpret the safety regulation (223). The third component of the AI model (207) may include one or more classification models, configured to determine one or more categorical indicators. The third component of the AI model (207) may include one or more regression models, configured to determine one or more numerical indicators, such as scores. The third component of the AI model (207) may include a computer vision model configured to assess whether safety devices are installed in the work environment and assign a score for each safety device. In such implementations, the third component of the AI model (207) includes a computer vision model that receives one or more images of the work environment as input. The one or more images of the work environment are included in the safety data (219). In some embodiments, the one or more images are captured by one or more cameras installed in the work environment. Examples of computer vision models that may be included in the third component of the AI model (207) include an object detection and classification model. The object detection and classification model is configured to detect, in an image, one or more safety devices and determine, for each safety device, a box encompassing the detected safety device. The object detection and classification model is further configured to assign a category for each detected safety device. Examples object detection and classification model include region-based convolutional neural networks (RCNN) and “you only look once” (YOLO) models. Thus, in some implementations, the third component of the AI model (207) includes a neural network, such as a fully connected neural network, a convolutional neural network, a recurrent neural network (RNN), a long short term memory (LSTM) network, a gated recurrent unit (GRU), a transformers model, or any combination of fully connected, convolutional, pooling, recurrent, LSTM, GRU, or normalization layers.

The safety state is used, read or interpreted to make the safety determination (225) whether the work activity (203) conforms to the safety regulation (223). In some embodiments, the safety determination (225) is made by an issuer. The issuer can be of various types. The issuer may include an individual, a plurality of individuals, a machine, or any combination thereof. In some embodiments, the issuer is part of the same regulatory entity as the regulator. In some implementations, the safety determination (225) is made by assigning a safety score to the work activity (203) and comparing the safety score to a pre-defined safety score threshold. If the safety score is greater than or equal to the safety score threshold, the work activity (203) is determined to conform to the safety regulation (223). If the safety score is less than the safety score threshold, the work activity (203) is determined not to conform to the safety regulation (223). In some implementations, the safety score is greater than or equal to the threshold when all safety controls (211) of the work activity conform to the safety regulation (223). In some implementations, the safety score is an average of scores included in the safety state. The safety determination (225) may be made depending on other factors, in addition to the safety state. In some embodiments, the issuer has visual or physical access to the work environment and the first determination is further based on a visual inspection of the work environment by the issuer. If the work activity (203) is determined to conform to the safety regulation (223), the work activity (203) continues.

If the work activity (203) is determined not to conform to the safety regulation (223), a remediation (227) is applied. The remediation (227) includes either of a correction procedure or a termination of the work activity (203). The correction procedure includes halting the work activity (203) and updating the safety control (211) based on the safety regulation (223). The safety control (211) is updated as an updated safety control to conform to the safety regulation (223). The updated safety control is implemented. In some embodiments, implementing the updated the safety control is done by the safety control system. After updating the safety control (211), the work activity (203) resumes in accordance with the implemented updated safety control. In some embodiments, the remediation (227) further includes a fine imposed on the work organization. In some embodiments, a projected economic impact of applying the correction procedure is first determined. Then, a decision is made whether to apply the correction procedure or abandon the work activity (203), based on the projected economic impact. In some embodiments, the projected economic impact is compared to a pre-defined economic impact threshold. If the projected economic impact is less than or equal to the pre-defined economic impact threshold, the correction procedure is applied. If the projected economic impact is greater than pre-defined economic impact threshold, the work activity (203) is abandoned. In one or more embodiments, the remediation (227) is applied by the issuer.

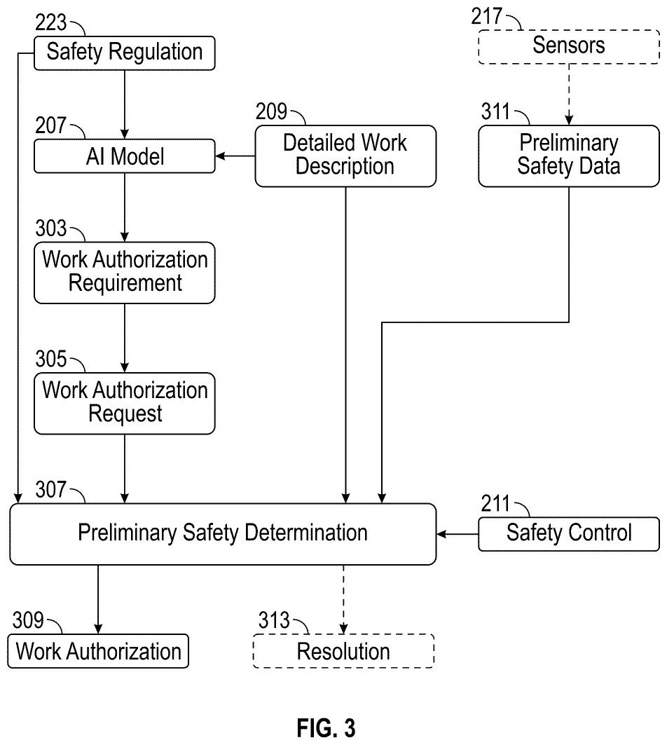

FIG. 3 depicts a system for sending a work authorization request and issuing a work authorization, in accordance with one or more embodiments. The AI model (207) receives, as input, the detailed work description (209) and the safety regulation (223). A fourth component of the AI model (207) returns, as output, a work authorization requirement (303). The work authorization requirement (303) may be of various types and include one or more components. The work authorization requirement (303) includes, at least, a binary indicator that indicates whether or not a work authorization is required for the work activity (203). The binary indicator may be a Boolean indicator equal to “true” if a work authorization is required for the work activity, or “false” if no work authorization is required for the work activity. The binary indicator may also be an integer equal to 1 if a work authorization is required for the work activity, or 0 if no work authorization is required for the work activity.

In some implementations, the work authorization requirement (303) further includes a type for the work authorization. If a work authorization is not required, the type, for the work authorization, may include a default value indicating that the work authorization type is not applicable. Examples of a default value for the work authorization type, include a text indicator such as “none” or “N/A”. The fourth component of the AI model (207), that is used to determine the work authorization requirement (303), includes, at least, a binary classification model that computes the binary indicator. The fourth component of the AI model (207) may further include a classification model that determines the work authorization type among a set of pre-defined work authorization types. The fourth component of the AI model (207) may further include one or more other classification models, one or more regression models, one or more text generators, or any combination thereof.

The work authorization requirement (303), output by the AI model (207), is received by the requester. If a work authorization is needed for the work activity (203), the requester sends a work authorization request (305) to the issuer for approval. The issuer is responsible for authorizing the work activity (203). The issuer is responsible for making a determination whether a work authorization is granted for the work activity (203). The issuer is responsible for responding to the work authorization request (305). If a work authorization is needed for the work activity (203), the work activity (203) only starts if the work authorization is approved by the issuer. If a work authorization is approved by the issuer, the work activity (203) only starts after the work authorization is approved by the issuer. The work authorization request (305) may be of various types. The work authorization request (305) includes, at least, a description of the work activity and a solicitation for a work authorization. In some embodiments, the description of the work activity is the detailed work description (209). In some embodiments, the solicitation for a work authorization is a textual question, such as “do you authorize the work activity?”. In some embodiments, the solicitation for a work authorization includes a form to be filled out by the issuer, the form including a box to be checked by the issuer if the work activity is approved. In some implementations, the form is computerized. In some embodiments, the solicitation for a work authorization includes a textual solicitation for a specific type of work authorization. In some embodiments, the work authorization request (305) includes the work authorization requirement (303). In some implementations, the work authorization request (305) includes a timeline to respond to the work authorization request (305). It is emphasized that the components of the work authorization request (305) described herein are given only as examples and should be considered non-limiting. One with ordinary skill in the art will readily appreciate that the work authorization request (305) may be structured differently without departing from the scope of this disclosure.

The issuer has access to the safety regulation (223), the detailed work description (209) and the safety control (211). In some embodiments, the safety regulation (223) is designed by the issuer. In order to determine whether to approve the work authorization request (305), the issuer conducts a preliminary safety assessment. The preliminary safety assessment includes at least two steps: obtaining preliminary safety data (311) and making a preliminary safety determination (307) whether the work activity (203) conforms to the safety regulation (223). The preliminary safety determination (307) is based on the detailed work description (209) and the safety control (211). While the safety assessment from the system in FIG. 2 is made while the work activity (203) is being performed, the preliminary safety assessment from the system in FIG. 3 is made before the work activity (203) begins. Thus, while the safety determination (225) in FIG. 2 is made while the work activity (203) is being performed, the preliminary safety determination (307) is made before the work activity (203) begins. Thus, the preliminary safety determination (307) differs from the safety determination (225) in FIG. 2. In particular, the post-deployable safety features have been scheduled but have not been deployed when the preliminary safety determination (307) is made. The preliminary safety determination (307) is a prediction whether the work activity (203), if performed as described in the detailed work description (209) and using the safety control (211), will be safe according to the safety regulation (223).

The issuer has access to the preliminary safety data (311) that are indicative of a state of the work activity (203). In some implementations, preliminary safety data (311) are indicative of whether the safety control (211) is implemented. In a similar fashion to the safety data (219) in the system in FIG. 2, the preliminary safety data (311) may include one or more of an image of the work environment, a video of the work environment, a sound recorded in the work environment, a temperature of the work environment, a pressure of the work environment, a level of a toxic gas in the work environment. The preliminary safety data (311) may further include personal data of workers performing the work activity, such as, for each worker, an age, a physical condition, a medical record and a psychological assessment. The preliminary safety data (311) may further include a record that a training program was completed by the workers. The preliminary safety data (311) may further include a record that a mail or electronic mail containing an evacuation plan was sent to workers selected to perform the work activity (203). In one or more embodiment, one or more components of the preliminary safety data (311) are captured by the one or more sensors (217), previously described in this disclosure.

Based on the preliminary safety data (311), the issuer makes the preliminary safety determination (307). In one or more embodiments, the preliminary safety determination (307) is made using the AI model (207). In one or more embodiments, the preliminary safety determination (307) is made using the third component of the AI model (207). In such embodiments, the third component of the AI model (207) receives, as input, the preliminary safety data (311) and returns, as output, a preliminary safety state for the work activity (203). The preliminary safety state is obtained in a similar fashion to the safety state that is used to make the safety determination (225) in FIG. 2. For concision, a full description of components and/or elements of the preliminary safety state is not provided anew for those components and/elements that have been previously described with reference to the safety state from the system in FIG. 2. In one or more embodiments, the preliminary safety state includes one or more categorical or numerical indicators. Each categorical indicator indicates whether a safety feature within the safety control (211) conforms to a component of the safety regulation (223). Each numerical indicator is a score assessing how closely the work activity (203) conforms to a component of the safety regulation (223). If the safety regulation (223) requires that a safety device be installed in the work environment, the preliminary safety state may include one or more binary indicators or one or more scores, or any combination thereof, assessing whether or how suitably the safety device is installed in the work environment. In some embodiments, the safety regulation (223) requires that the pre-deployable safety features and the post-deployable safety features be deployed. In such embodiments, the preliminary safety state may include, for each pre-deployable safety feature, a binary indicator indicating whether the pre-deployable safety feature is deployed. The preliminary safety state may further include, for each post-deployable safety feature, a binary indicator indicating whether the post-deployable safety feature is scheduled to be deployed.

In some embodiments, the safety regulation (223) includes one or more safety devices to be installed in the work environment and further includes, for each safety device, a specific location at which the safety device must be installed. In such embodiments, the preliminary safety state may include a map of the work environment and one or more indicators assessing the safety devices on the map. The one or more indicators may be configured in many ways. In some implementations, the one or more indicators includes one indicator for each safety device. For a given safety device, the indicator is defined as a pair composed of a score and a circular box with a certain color. The circular box is centered at a specific location at which the safety device is required to be installed as per the safety regulation (223). In some implementations, the color of the box is green if the given safety device is installed within the box, and red if the given safety device is not installed within the box. The score indicates how close to the specific location the given safety device is installed. In some implementations, the score is equal to

$$1 - \frac{P - C}{R}$$

if the box is green, where P stands for the position where the given item is installed, C denotes the center of the box and R denotes a radius of the box. The score is equal to 0 if the box is red.

In some embodiments, the issuer has visual or physical access to the work environment and the preliminary safety determination (307) is further based on a visual inspection of the work environment by the issuer. If the work activity (203) is determined to conform to the safety regulation (223), the issuer issues a work authorization (309). The work authorization (309) may be of several types. In some implementations, the work authorization (309) is, or includes a verbal authorization to perform the work activity (203). In other implementations, the work authorization (309) is, or includes a written authorization, in the form of a letter or an electronic file. In some implementations, the work authorization (309) is or includes a work permit. Examples of work permits are given in Table II. In one or more embodiments, the issuer orders a resolution (313) if the work activity (203) is determined not to conform to the safety regulation (223). The resolution (313) includes either of an abandonment of the work activity (203) or a safety update. The safety update includes updating the safety control (211) to conform to the safety regulation (223), and implement the updated safety control.

The systems from FIGS. 2 and 3 may be combined to form a consolidated, AI-assisted work authorization system. The work summary (205) for the work activity (203) is obtained from the requester. Using the work summary (205) as input, the first component of the AI model (207) is used to determine the detailed work description (209) as output. The detailed work description (209) includes, at least, one or more hazards associated with the work activity. Using the detailed work description (209) as input, the second component of the AI model (207) is used to determine the safety control (211) to mitigate the one or more hazards. The safety control (211) is implemented by a safety control system.

Using the work summary (205) and the safety regulation (223) as inputs, the fourth component of the AI model (207) outputs the work authorization requirement (303). The work authorization requirement (303) is returned to the requester. If a work authorization is required for the work activity (203), the requester makes a work authorization request (305) to the issuer. The issuer makes a preliminary safety assessment that includes the safety assessment preliminary safety determination (307) whether the work activity (203) conforms to the safety regulation (223). The preliminary safety determination (307) is made using the preliminary safety data (311). In some embodiments, the third component of the AI model (207) is used, by the issuer, to determine a preliminary safety state, using the preliminary safety data (311) as input. The issuer bases the preliminary safety determination (307) on the preliminary safety state. In some embodiments, the preliminary safety data (311) includes components captured by one or more sensors (217), such as a thermometer, a camera and a barometer. In some implementations, the preliminary safety data (311) includes one or more images of the work environment and the third component of the AI model (207) includes a computer vision model that receives the one or more images as inputs and returns, as output, one or more indicators included in the preliminary safety state. As a non-limiting example, the computer vision model may be able determine whether a safety device is installed as a requirement from the safety regulation (223). In some embodiments, the issuer has visual or physical access to the work environment and the preliminary safety determination (307) is further based on a visual inspection of the work environment by the issuer.

If the work activity (203) is determined to conform to the safety regulation (223), the issuer issues a work authorization (309). If the work activity (203) is determined not to conform to the safety regulation (223), the issuer orders a resolution (313). The resolution (313) includes either of an abandonment of the work activity (203) or updating one or more preliminary safety measures in order for the work activity (203) to conform to the safety regulation (223). The work authorization (309) is sent to the requester and the work activity (203) is performed. While the work activity (203) is being performed, the issuer performs a safety assessment that includes making a safety determination (225) whether the work activity (203) conforms to the safety regulation (223). To make the safety determination (225), safety data (219) is sent as input to the AI model (207). The third component of the AI model (207) returns, as output, a safety state for the work activity (203). The safety state is indicative of a state of the work activity (203). In some embodiments, the safety state includes one or more indicators of how suitably the safety control (211) is implemented. In some embodiments, the safety data (219) include components captured by the one or more sensors (217), such as a thermometer, a camera and a barometer. Based on the safety state, the issuer makes the safety determination (225). In some embodiments, the issuer has visual or physical access to the work environment and the safety determination (225) is further based on a visual inspection of the work environment by the issuer. If the work activity (203) is determined to conform to the safety regulation (223), the work activity (203) continues. If the work activity (203) is determined not to conform to the safety regulation (223), a remediation (227) is applied. The remediation (227) includes either of a correction procedure or a termination of the work activity (203). The correction procedure includes halting the work activity (203) and updating the safety control (211) based on the safety regulation (223).

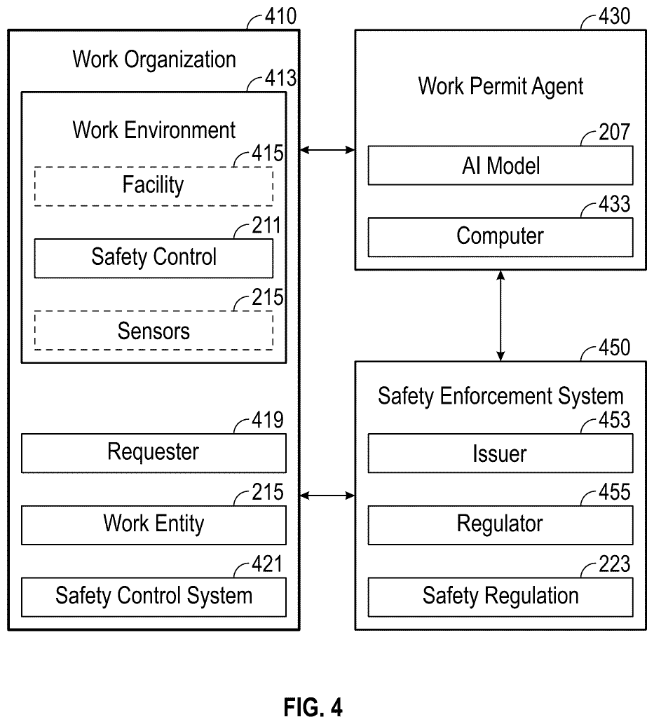

FIG. 4 depicts a specific embodiment of an AI-assisted work authorization system for a work activity. For concision, a full description of components and/or elements depicted in FIG. 4 is not provided anew for those components and/elements that have be previously described with reference to the preceding figures. The system in FIG. 4 includes a work organization (410), a work permit agent (430) and a safety enforcement system (450). The work organization (410) includes a work environment (413), a requester (419), the work entity (215) and a safety control system (421). The safety control system is structured to implement the safety control (211) in the work environment (413). In some embodiments, the work environment (413) further includes a facility (415). The facility (415) can be of various types, depending on the work activity. Examples of the facility (415) includes, but are not limited to, an office, a processing plant, a manufacturing plant, a power plant, a well drilling site, a hydrocarbon production well site, a data center, a store, a gymnasium and a restaurant. The work entity (215) is structured to perform a work activity. The requester (419) is structured to define a work summary for the work activity, send a command for the safety control system to implement the safety control, send a work authorization request to an issuer (453), receive a work authorization from the issuer (453) and send a command for the work entity (215) to perform the work activity. The requester (419) is further structured to send information to the AI model (207) and receive information from the AI model (207).

The safety enforcement system (450) includes the issuer (453), a regulator (455) and the safety regulation (223). The regulator (455) is configured to define the safety regulation (223) and send the safety regulation (223) to the issuer (453) and the AI model (207). The issuer (453) is structured to receive the work authorization request from the requester (419) and send the work authorization to the requester (419). The issuer (453) is further structured to make a work authorization determination whether the work activity is granted a work authorization. The issuer (453) is further structured to send information to the AI model (207) and receive information from the AI model (207). The issuer (453) is further structured to make a preliminary safety determination whether the work activity conforms to the safety regulation (223). The issuer (EEE05) is further structured to apply a resolution in response to the preliminary safety determination that the work activity does not conform to the safety regulation (223). The issuer (453) is further structured to make a safety determination whether the work activity conforms to the safety regulation (223). The issuer (EEE05) is further structured to apply a remediation in response to the safety determination that the work activity does not conform to the safety regulation (223).

The work permit agent (430) includes the AI model (207) and a computer (433), on which the AI model (207) is hosted and run. The AI model (207) is a multimodal model, that includes a plurality of components. The AI model (207) is used to automate some of the work authorization request and issuance. The AI model (207) is further used to determine whether the work activity conforms to the safety regulation (223). The AI model (207) is configured to receive the work summary from the requester (419) and return, to the requester (419), a detailed work description including one or more hazards associated with the work activity. The AI model (207) is further configured to receive, as input, the detailed work description and return, as output to the requester (419), a safety control to mitigate the one or more hazards. The AI model (207) is further configured to receive, as input, the detailed work description and the safety regulation (223) and return, as output to the requester (419), a work authorization requirement whether a work authorization is required to perform the work activity. The AI model (207) is further configured to receive preliminary safety data as input and return, as output, a preliminary safety state. Based on the preliminary safety state, the issuer (453) makes a preliminary safety determination whether the work activity conforms to the safety regulation (223). The AI model (207) is further configured to receive safety data as input and return, as output, a safety state. Based on the safety state, the issuer (453) makes a safety determination whether the work activity conforms to the safety regulation (223).

As described herein and in accordance with one or more embodiments, the AI model (207) is a multimodal model that includes, at least, four components. The first component of the AI model (207) receives, as input, a work summary for a work activity and returns, as output, a detailed work description of the work activity. The detailed work description of the work activity includes one or more hazards associated with the work activity. The second component of the AI model (207) receives, as input, the detailed work description of the work activity and returns, as output, a safety control to mitigate the one or more hazards associated with the work activity. The third component of the AI model (207) receives, as input, safety data for a work activity and returns, as output, a safety state for the work activity. The third component of the AI model (207) may further receive, as input, preliminary safety data for a work activity and returns, as output, a preliminary safety state for the work activity The fourth component of the AI model (207) receives, as input, a pair composed of a safety regulation and a detailed work description of a work activity and returns, as output, a binary indicator indicating whether the work activity requires a work authorization prior to being performed.

Artificial intelligence models typically involve a training phase and a testing phase, both using previously acquired data. Supervised machine-learned models require examples of input and associated output (i.e., target) pairs in order to learn a desired functional mapping. The AI model (207) may be trained using work data obtained from work activities that were performed in the past. The work data include names of work activities that were performed in the past. The work data further includes, at least, for each work activity, a work summary, a detailed work description, one or more hazards associated with the work activity, a safety control that was determined to mitigate the one or more hazards and a result of a determination whether the work activity requires a work authorization. In one or more embodiments, the one or more classification models, regression models and text generators composing the multimodal AI model (207) are trained separately. One with ordinary skill in the art will recognize that a full discussion of the training of every type of component composing the AI model (207) is not possible nor required to describe the systems and methods in this disclosure. Therefore, a brief discussion is provided herein.

For each component of the AI model (207), a dataset of examples may be constructed, each example including an input and an associated output (i.e., target) for a distinct past work activity. An example input for the first component is a work summary for a past work activity and an associated output, or target, is a detailed work description of the past work activity. The detailed work description of the past work activity includes one or more hazards associated with the past work activity. An example input for the second component is the detailed work description of the past work activity and an associated output, or target, is a safety control to mitigate the one or more hazards associated with the past work activity. An example input for the third component is safety data for a past work activity, in a same format as the safety data (219) in FIG. 2. An associated output, or target, for the third component is a safety state for the past work activity in the same format as the safety state output by the AI model (207) in FIG. 2. An example input for the fourth component is a pair composed of a safety regulation and a detailed work description of a past work activity and an associated output, or target, is a binary indicator indicating whether the past work activity requires a work authorization prior to being performed.

In one or more embodiments, the dataset is split into a training dataset and a testing dataset. The example input and associated output pairs of the training dataset are called training examples. The example input and associated output pairs of the testing dataset are called testing examples. It is common practice to split the dataset in a way that the training dataset contains more examples than the testing dataset. Because data splitting is a common practice when training and testing a machine-learned model, it is not described in detail in this disclosure. One with ordinary skill in the art will recognize that any data splitting technique may be applied to the dataset without departing from the scope of this disclosure. Each component of the AI model (207) is trained as a functional mapping that optimally matches the inputs of the training examples to the associated outputs of the training examples.

Once trained, a given component of the AI model (207) is validated by computing a metric for the testing examples, in accordance with one or more embodiments. Denoting m as the number of testing examples, the input of the ith testing example is denoted as xᵢ, for i=1, . . . , m. If the output of the examples includes one or more numerical component, the one or more numerical components of the output of the ith testing example may be arranged as a vector yᵢ, for i=1, . . . , m. The output of the given component of the AI model (207) receiving xᵢ as input also includes one or more numerical components, that may be arranged as a vector ŷᵢ, for i=1, . . . , m. In such scenarios, examples of metrics that may be used to validate the given component of the AI model (207) include any scoring or comparison function known in the art, including but not limited to: a mean square error (MSE), a root mean square error (RMSE) and a coefficient of determination (R²), defined respectively as:

$$MSE = \frac{1}{m} {\sum }_{i = 1}^{i = m} {\vert {\hat{y}}_{i} - {y}_{i} \vert}^{2} , \qquad EQ . 1$$

$$RMSE = \sqrt{\frac{1}{m} {\sum }_{i = 1}^{i = m} {\vert {\hat{y}}_{i} - {y}_{i} \vert}^{2}} , \qquad EQ . 2$$

$${R}^{2} = 1 - \frac{{\sum }_{i = 1}^{i = m} {\vert {\hat{y}}_{i} - {y}_{i} \vert}^{2}}{{\sum }_{i = 1}^{i = m} {\vert {y}_{i} - \overline{y} \vert}^{2}} . \qquad EQ . 3$$

### In EQ. 1, EQ. 2, and EQ. 3,

$$\overline{y} = \frac{1}{m} {\sum }_{i = 1}^{i = m} {y}_{i} .$$

The notation |·| denotes a norm that can be applied to the object in between, such an l₂ norm. If the output of the interpretation examples includes a categorical component, the value of the categorical component for the i^{th} testing example may be denoted as yᵢ, for i=1, . . . , m. For all i=1, . . . , m, the value of yᵢ is a category within a plurality of categories Cⱼ, for j=1, . . . , C, where C denotes a number of categories in a classification. The output of the given component of the AI model (207) receiving xᵢ as input includes a prediction for yᵢ, denoted by ŷᵢ, for i=1, . . . , m. In such scenarios, examples of metrics that may be used to validate the given component of the AI model (207) include an accuracy (ACC), defined as:

$$ACC = \frac{1}{m} {\sum }_{i = 1}^{i = m} δ ( {\hat{y}}_{i} , {y}_{i} ) . \qquad EQ . 4$$

In EQ. 4, δ is the symbol of Kronecker, defined by δ (ŷᵢ, yᵢ)=1 if ŷᵢ=yᵢ, or δ(ŷᵢ, yᵢ)=0 otherwise. In some embodiments, the categorical component yᵢ is one-hot encoded as a vector with components yᵢ^{j}, for j=1, . . . , C, where yᵢ^{j}=δ(yᵢ, Cⱼ). The prediction for yᵢ, denoted by ŷᵢd, is also a vector, with components ŷᵢ^{j}, each component denoting a probability score between 0 and 1, for j=1, . . . , C. In these embodiments, examples of metrics that may be used to validate the given component of the AI model (207) include a categorical cross-entropy (CAT), defined as:

$$CAT = - \frac{1}{m} {\sum }_{i = 1}^{i = m} {\sum }_{j = 1}^{j = C} {y}_{i}^{j} log ( {\hat{y}}_{i}^{j} ) . \qquad EQ . 5$$

If the output of the examples includes a generated text, the generated text for the i^{th} testing example may be denoted as yᵢ, for i=1, . . . , m. The output of the given component of the AI model (207) receiving xᵢ as input includes a prediction for yᵢ, denoted by ŷᵢ, for i=1, . . . , m. In such scenarios, examples of metrics that may be used to validate the given component of the AI model (207) includes a text similarity, such as a bleu score.

In one or more embodiments, the outputs of the examples include one or more numerical components, one or more categorical components, one or more generated texts, or any combination thereof. In such embodiments, examples of metrics that may be used to validate the given component of the AI model (207) include combinations of metrics taken from EQs. 1-5.

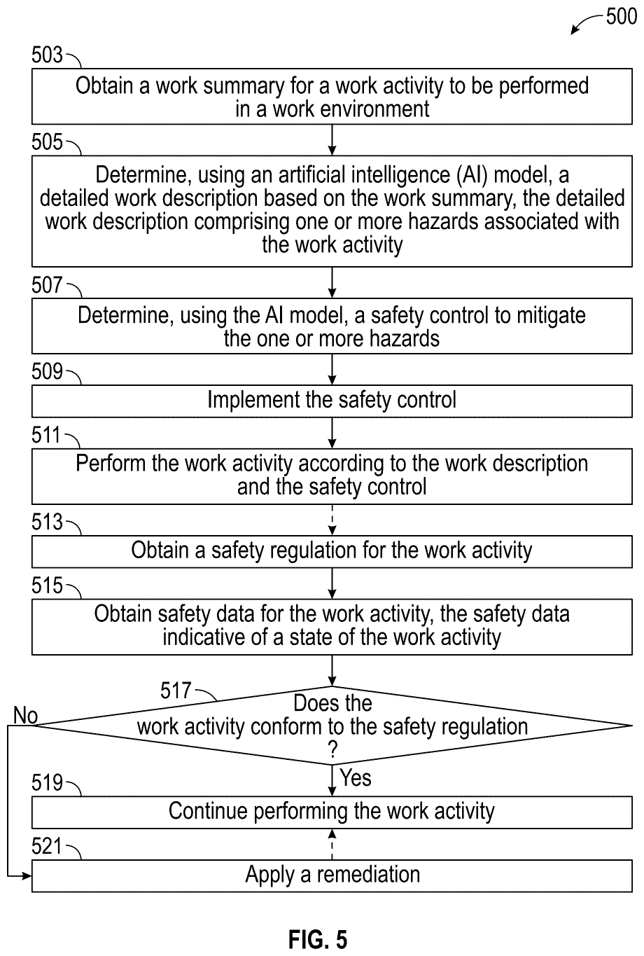

The flow chart in FIG. 5 delineates a method for determining and implementing a safety control to mitigate hazards associated with a work activity, in accordance with one or more embodiments. The method in FIG. 5 further includes performing and monitoring safety the work activity. For concision, a full description of components and/or elements depicted in FIG. 5 is not provided anew for those components and/elements that have be previously described with reference to the preceding figures. In Step 503, a work summary is obtained for a work activity to be performed in a work environment. The work environment can be of many types. Examples of work environments include, but are not limited to, a construction site, a processing plant, a well drilling site and a hydrocarbon production well site, as shown in FIGS. 1A-1D. The work activity can be of many types. Examples of work activities include an excavation, masonry, carpentry, electrical work, plumbing, roof installation, operating heavy machinery, construction planning, designing a process flow, engineering, operating a gas processing unit, managing material flow rates, electrical work, chemical work, assembling a derrick, operating a drill string, operating a mud flow, fracking, optimizing a drilling rate, cementing, installing a well casing, performing maintenance or repair, operating the pumpjack, monitoring production fluid flow rates, well planning, transportation and logistics. The method in FIG. 5 should not be considered as limiting the work activity to a particular configuration. The method in FIG. 5 should not be considered as limiting the work environment to a particular configuration. The work summary can be of various types, in a similar fashion to the work summary (205) in FIG. 2. As such, the work summary in Step 503 may include one or more of a short textual description of the work activity, a name for the work activity, the work environment, and a location where the work activity is to be performed.

In Step 505, the work summary is sent as input to an artificial intelligence (AI) model. The AI model in Step 505 is a multimodal model, implemented as the AI model (207) in the systems in FIGS. 2-4. As such, the AI model in Step 505 may include one or more of a natural language processing models and one or more computer vision models. The AI model in Step 505 may include a neural network, such as a fully connected neural network, a convolutional neural network, a recurrent neural network (RNN), a long short term memory (LSTM) network, a gated recurrent unit (GRU), a transformers model, or any combination of fully connected, convolutional, pooling, recurrent, LSTM, GRU, or normalization layers. The AI model in Step 505 may include other structures outside of the ones described herein without departing from the scope of this disclosure. In Step 505, the AI model returns, as output, a detailed work description of the work activity from Step 503. The detailed work description is configured in the same way and with the same format as the detailed work description (209) in FIG. 2. The detailed work description in Step 505 includes, at least, one or more hazards associated with the work activity. Examples of hazards are described in Tables I and II.

In Step 507, the AI model receives, as input, the detailed work description from Step 505 and returns, as output, a safety control to mitigate the one or more hazards from Step 505. Examples for the safety control include the safety control (211) from FIG. 2. The safety control in Step 507 includes one or more safety features. Examples of safety features are listed in Table I. As returned by the AI model, the safety control may include a list of names of one or more safety features, a textual description of each of the one or more safety measures, a suggested equipment to implement the safety control, a time frame for the safety control, a cost of implementing the safety control, one or more images of the safety control, a resource required to implement the safety control, such a human resource, a machine, a material and a computer. The safety control includes pre-deployable safety before the work activity begins. A post-deployable safety feature is deployed after the work activity begins or exactly when the work activity begins.

The safety control is implemented in Step 509. In one or more embodiments, the safety control is implemented by a safety control system, in a similar fashion as the safety control (211) in FIG. 2. Implementing the safety control includes deploying the pre-deployable safety features and scheduling to deploy the post-deployable safety features. In that regard, examples of steps of the implementation of the safety control include installing an affixed safety device in the work environment, conducting preparatory safety training, sending a preparatory communication to workers, and planning for the workers to use the protective gear.

In Step 511, the work activity is performed according to the detailed work description from Step 505 and the safety control from Steps 507 and 509. The work activity is performed in a similar fashion to the work activity (203) in FIG. 2. In some embodiments, performing the work activity according to the safety control includes deploying the post-deployable safety features during the work activity. In accordance with one or more embodiments, a safety regulation is obtained for the work activity in Step 513. The safety regulation can be of many types. Examples of the safety regulation include the safety regulation (223) from FIG. 2. As such, the safety regulation is obtained from a regulator. The safety regulation may include one or more components. In some implementations, the safety regulation includes a textual definition of a safe work environment for the work activity. In some implementations, the safety regulation imposes that a specific safety feature be implemented for the work activity. For instance, in some embodiments, the safety regulation (223) includes a requirement that a given affixed safety device be installed, such as a machine guard, a handrail, a barrier, a ventilation system, a fire extinguisher, a first aid kit, an ergonomic office workstation and an evacuation map of the work environment. In some implementations, the safety regulation includes a safety guideline. In scenarios where the work activity is not hazardous, the safety regulation may include a tag saying that the work activity is not hazardous. In some embodiments, the safety regulation (223) requires that the pre-deployable safety features and the post-deployable safety features be deployed.

In Step 515, safety data is obtained for the work activity, while the work activity is being performed. The safety data is indicative of a state of the work activity. The safety data can be of many types. Examples of safety data include the safety data (219) from FIG. 2. As such, the safety data may be composed of one or more components including, as non-limiting examples, an image of the work environment, a video of the work environment, a sound recorded in the work environment, a temperature of the work environment, a pressure of the work environment and a level of a toxic gas in the work environment. In some embodiments, some components of the safety data are captured by one or more sensors installed in the work environment, such as the one or more sensors (217) in FIG. 2.

In Step 517, a safety determination is made whether the work activity conforms to the safety regulation, in a similar fashion to the safety determination (225) in FIG. 2. The safety determination is made using the AI model that receives the safety data from Step 515 as input and returns, as output, a safety state for the work activity. The safety state may be of several types. As non-limiting examples, the safety state may include one or more indicators, one or more scores, or any combination thereof, assessing whether or how suitably the work activity conforms to the safety regulation. In some implementations, the safety determination is made by assigning a safety score to the work activity and comparing the safety score to a pre-defined safety score threshold. If the safety score is greater than or equal to the safety score threshold, the work activity is determined to conform to the safety regulation. If the safety score is less than the safety score threshold, the work activity is determined not to conform to the safety regulation. If the work activity is determined to conform to the safety regulation, the work activity continues in Step 519. If the work activity is determined not to conform to the safety regulation, a remediation is applied in Step 521. The remediation in Step 521 is similar to the remediation (227) in FIG. 2. As such, the remediation in Step 521 includes either of a correction procedure or a termination of the work activity. The correction procedure includes halting the work activity and updating the safety control based on the safety regulation. The safety control (211) is updated as an updated safety control to conform to the safety regulation. The updated safety control is implemented. After updating the safety control, the work activity may resume in Step 519, in accordance with the implemented updated safety control.

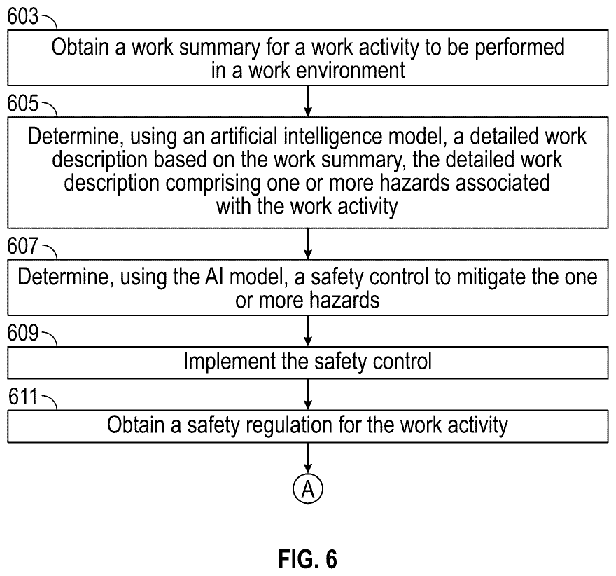

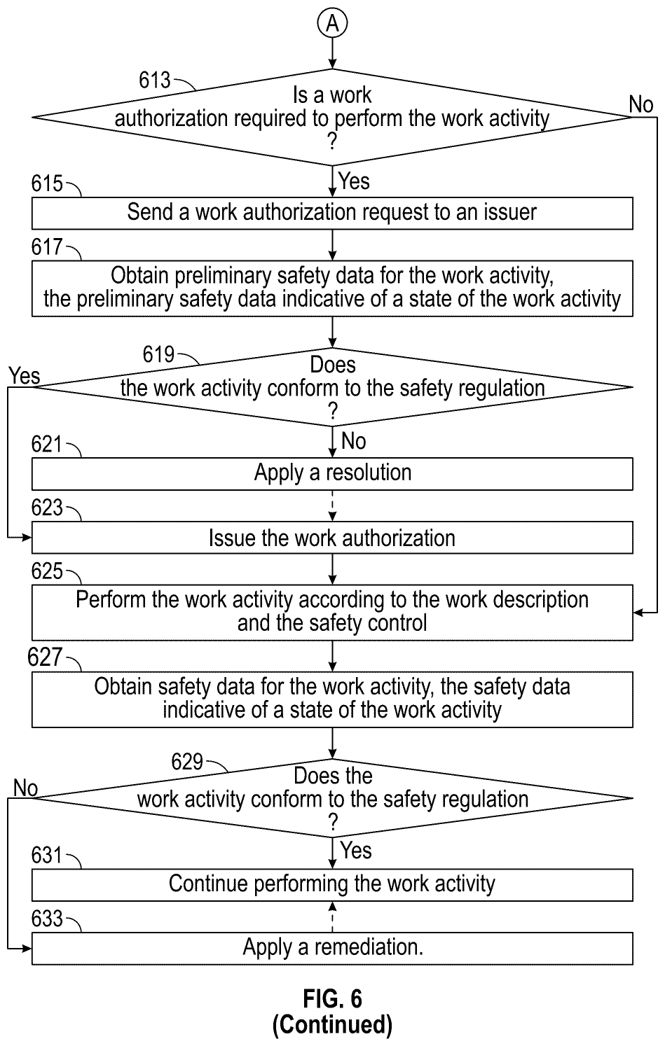

The flow chart in FIG. 6 delineates a method for issuing a work authorization for a work activity and monitoring safety of the work activity, in accordance with one or more embodiments. For concision, a full description of components and/or elements depicted in FIG. 6 is not provided anew for those components and/elements that have be previously described with reference to the preceding figures. In Step 603, a work summary is obtained for a work activity to be performed in a work environment, in a similar fashion to Step 503 in method (500). In some embodiments, the work summary is created by a requester. In Step 605, the work summary is sent as input to an artificial intelligence (AI) model that returns, as output, a detailed work description of the work activity from Step 603, similarly to Step 505 in method (500). The detailed work description in Step 605 includes, at least, one or more hazards associated with the work activity. Step 607 is similar to Step 507 of method (500). In Step, 607, the AI model receives, as input, the detailed work description from Step 605 and returns, as output, a safety control to mitigate the one or more hazards from Step 605. The safety control is implemented in Step 609. In some embodiments, the safety control is implemented by a safety control system. In some embodiments, the requester sends a command for the safety control system to implement the safety control. A safety regulation is obtained for the work activity in Step 611. The safety regulation can be of many types. Examples of the safety regulation include the safety regulation (223) from FIG. 2.

In Step 613, a work authorization determination is made whether a work authorization is required to perform the work activity. The work authorization determination is obtained as an output of the AI model using, as inputs, the detailed work description from Step 605 and the safety regulation from Step 611. The work authorization determination is obtained in the same way as the work authorization requirement (303) in FIG. 3. If a work authorization is required to perform the work activity, a work authorization request is sent to an issuer in Step 615. In some embodiments, the work authorization is sent, to the issuer, by the requester. In some embodiments, the work authorization includes a type for the work authorization. In some embodiments, the work authorization is a work permit. Examples of work permits are given in Table II. If a work authorization is not required to perform the work activity, the work activity is performed according to the work description and the safety control in Step 625.

In some embodiments, the issuer in Step 615 is part of a safety enforcement system, in the same way as the issuer (453) is part of the safety enforcement system (450) in FIG. 4. The issuer may be of various types and include an individual, a plurality of individuals, a machine, or any combination thereof. The issuer is responsible for deciding whether to issue the work authorization. In order to decide whether to issue the work authorization, the issuer performs a preliminary safety assessment for the work activity. As part of the preliminary safety assessment, preliminary safety data is obtained for the work activity in Step 617. The preliminary safety data is indicative of a state of the work activity. The preliminary safety data is similar to the preliminary safety data (311) in FIG. 3. As such, the preliminary safety data in Step 617 may be of various types and may include one or more of an image of the work environment, a video of the work environment, a sound recorded in the work environment, a temperature of the work environment, a pressure of the work environment, a level of a toxic gas in the work environment. In some embodiments, some components of the preliminary safety data are captured by one or more sensors installed in the work environment, such as the one or more sensors (217) in FIGS. 2 and 3. As non-limiting examples, the one or more sensors may include one or more of a camera, a gas detector, a thermometer, a microphone and a barometer. The preliminary safety data may be received by the issuer or the AI model, or both.

As part of the preliminary safety assessment, a preliminary safety determination is made in Step 619, based on the preliminary safety data from Step 617, whether the work activity conforms to the safety regulation from Step 611. The preliminary safety determination in Step 619 is similar to the preliminary safety determination (307) in FIG. 3. In order to make the preliminary safety determination, the issuer verifies, using the preliminary safety data from Step 617, that the work activity conforms to the safety regulation. In some embodiments, the safety regulation requires that a safety device be installed in the work environment and the issuer verifies that the safety device is installed in the work environment. In some embodiments, the safety regulation requires that a safety device be installed according to an installation rule in the work environment and the issuer verifies that the safety device is installed according to the installation rule in the work environment. In a similar fashion to the preliminary safety determination (307) in FIG. 3, the preliminary safety determination in Step 617 may be assisted by the AI model that receives, as input, the preliminary safety data and returns, as output, a preliminary safety state for the work activity. The issuer has access to the safety regulation. The issuer bases the preliminary safety determination (307) on the preliminary safety state. In some embodiments, the AI model includes a computer vision model and the preliminary safety data includes visual data. The visual data includes one or more images, one or more videos, or any combination thereof. In such embodiments, the computer vision model determines, using the visual data as input, one or more indicators that assess whether the safety device is installed in the work environment. In some implementations, the computer vision model determines, using the visual data as input, a score assessing how suitably the safety device is installed in the work environment. The indicators resulting from the computer vision model are included in the preliminary safety state.

If the work activity is determined to conform to the safety regulation, the issuer issues the work authorization in Step 623. In some embodiments, the work authorization is sent to the requester. If the work activity is determined not to conform to the safety regulation, the issuer orders to apply a resolution in Step 621. The resolution in Step 621 is similar to the resolution (313) in FIG. 3. The resolution includes either of an abandonment of the work activity or a safety update. The safety update includes updating the safety control to conform to the safety regulation, and implementing the updated safety control. After performing the safety update, the issuer may issue the work authorization in Step 623. In Step 625, the work activity is performed according to the detailed work description and the safety control, in the same way as Step 511 of method (500). In some embodiments, the work activity is performed by a work entity. In some embodiments, the requester sends a command for the work entity to perform the work activity. In some embodiments, the requester, safety control system and work entity are part of a same work organization, such as the work organization (410) in FIG. 4.

Steps 627-633 define a safety assessment applied in the same fashion to the safety assessment in Steps 515-521 in method (500). As part of the safety assessment, safety data is obtained for the work activity in Step 627, while the work activity is being performed. The safety data is indicative of a state of the work activity. As part of the safety assessment a safety determination is made in Step 629, whether the work activity conforms to the safety regulation. The safety determination is made by analyzing a safety state output by the AI model that receives the safety data from Step 627 as input. While the preliminary safety assessment in Steps 617-619 is made before the work activity begins, the safety assessment in Steps 627-629 is made while the work activity is being performed. If the work activity is determined to conform to the safety regulation, the work activity continues in Step 631. If the work activity is determined not to conform to the safety regulation, a remediation is applied in Step 633. The remediation in Step 633 includes either of a correction procedure or a termination of the work activity. The correction procedure includes halting the work activity and updating the safety control based on the safety regulation. The safety control is updated as an updated safety control to conform to the safety regulation. The updated safety control is implemented. After updating the safety control, the work activity may resume in Step 631, in accordance with the implemented updated safety control.

As previously described, the AI model in this disclosure, represented by the AI model (207) in FIGS. 2, 3 and 4, may be configured in many ways. Artificial intelligence (AI), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence will be adopted herein, however, one skilled in the art will recognize that the concepts and methods detailed hereafter are not limited by this choice of nomenclature.

AI model types may include, but are not limited to, generalized linear models, Bayesian regression, random forests, and deep models such as neural networks, convolutional neural networks, and recurrent neural networks. AI model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding an AI model is referred to as selecting the model “architecture.” Once an AI model type and hyperparameters have been selected, the AI model is trained to perform a task.

A notable example of an AI model that may be used as the AI model (207) or any component of the AI model (207) is a neural network (NN), such as a convolutional neural network (CNN). A cursory introduction to a NN is provided herein. However, it is noted that many variations of a NN exist. Therefore, one with ordinary skill in the art will recognize that any variation of the NN (or any other AI model) may be employed without departing from the scope of this disclosure. Further, it is emphasized that the following discussions of a NN is a basic summary and should not be considered limiting.

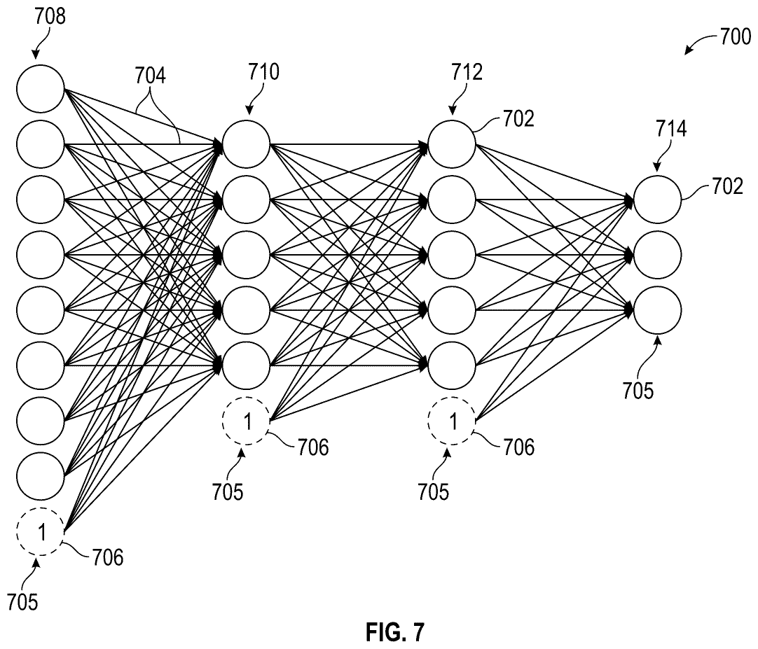

A diagram of a neural network is shown in FIG. 7. At a high level, a neural network (700) may be graphically depicted as being composed of nodes (702), where here any circle represents a node, and edges (704), shown here as directed lines. The nodes (702) may be grouped to form layers (705). FIG. 7 displays four layers (708, 710, 712, 714) of nodes (702) where the nodes (702) are grouped into columns, however, the grouping need not be as shown in FIG. 7. The edges (704) connect the nodes (702). Edges (704) may connect, or not connect, to any node(s) (702) regardless of which layer (705) the node(s) (702) is in. That is, the nodes (702) may be sparsely and residually connected. A neural network (700) will have at least two layers (705), where the first layer (708) is considered the “input layer” and the last layer (714) is the “output layer.” Any intermediate layer (710, 712) is usually described as a “hidden layer.” A neural network (700) may have zero or more hidden layers (710, 712) and a neural network (700) with at least one hidden layer (710, 712) may be described as a “deep” neural network or as a “deep learning method.” In general, a neural network (700) may have more than one node (702) in the output layer (714). In this case the neural network (700) may be referred to as a “multi-target” or “multi-output” network.

Nodes (702) and edges (704) carry additional associations. Namely, every edge is associated with a numerical value. The edge numerical values, or even the edges (704) themselves, are often referred to as “weights” or “parameters.” While training a neural network (700), numerical values are assigned to each edge (704). Additionally, every node (702) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad EQ . 6$$

where i is an index that spans the set of “incoming” nodes (702) and edges (704) and ƒ is a user-defined function. Incoming nodes (702) are those that, when the neural network (700) is viewed or depicted as a directed graph (as in FIG. 7), have directed arrows that point to the node (702) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max (0, x), however, many additional functions are commonly employed. Every node (702) in a neural network (700) may have a different associated activation function. Often, as a shorthand, activation functions are described by the function ƒ by which it is composed. That is, an activation function composed of a linear function ƒ may simply be referred to as a linear activation function without undue ambiguity.

When the neural network (700) receives an input, the input is propagated through the network according to the activation functions and incoming node (702) values and edge (704) values to compute a value for each node (702). That is, the numerical value for each node (702) may change for each received input. Occasionally, nodes (702) are assigned fixed numerical values, such as the value of 1, that are not affected by the input or altered according to edge (704) values and activation functions. Fixed nodes (702) are often referred to as “biases” or “bias nodes” (706), displayed in FIG. 7 with a dashed circle.

In some implementations, the neural network (700) may contain specialized layers (705), such as a normalization layer, or additional connection procedures, like concatenation. One skilled in the art will appreciate that these alterations do not exceed the scope of this disclosure.

As noted, the training procedure for the neural network (700) comprises assigning values to the edges (704). To begin training the edges (704) are assigned initial values. These values may be assigned randomly, assigned according to a prescribed distribution, assigned manually, or by some other assignment mechanism. Once edge (704) values have been initialized, the neural network (700) may act as a function, such that it may receive inputs and produce an output. As such, at least one input is propagated through the neural network (700) to produce an output. Training data is provided to the neural network (700). Generally, training data consists of pairs of inputs and associated targets. The targets represent the “ground truth,” or the otherwise desired output, upon processing the inputs. In the context of this disclosure, the AI model is a multimodal model with a plurality of components that may each include a neural network. An example input for the first component is a work summary for a past work activity and an associated output, or target, is a detailed work description of the past work activity. The detailed work description of the past work activity includes one or more hazards associated with the past work activity. An example input for the second component is the detailed work description of the past work activity and an associated output, or target, is a safety control to mitigate the one or more hazards associated with the past work activity. An example input for the third component is safety data for a past work activity, in a same format as the safety data (219) in FIG. 2. An associated output, or target, for the third component is a safety state for the past work activity in the same format as the safety state output by the AI model (207) in FIG. 2. An example input for the fourth component is a pair composed of a safety regulation and a detailed work description of a past work activity and an associated output, or target, is a binary indicator indicating whether the past work activity requires a work authorization prior to being performed. During training, the neural network (700) processes at least one input from the training data and produces at least one output. Each neural network (700) output is compared to its associated input data target. The comparison of the neural network (700) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (700) output and the associated target. The loss function may also be constructed to impose additional constraints on the values assumed by the edges (704), for example, by adding a penalty term, which may be physics-based, or a regularization term. Generally, the goal of a training procedure is to alter the edge (704) values to promote similarity between the neural network (700) output and associated target over the training data. Thus, the loss function is used to guide changes made to the edge (704) values, typically through a process called “backpropagation.”

While a full review of the backpropagation process exceeds the scope of this disclosure, a brief summary is provided. Backpropagation consists of computing the gradient of the loss function over the edge (704) values. The gradient indicates the direction of change in the edge (704) values that results in the greatest change to the loss function. Because the gradient is local to the current edge (704) values, the edge (704) values are typically updated by a “step” in the direction indicated by the gradient. The step size is often referred to as the “learning rate” and need not remain fixed during the training process. Additionally, the step size and direction may be informed by previously seen edge (704) values or previously computed gradients. Such methods for determining the step direction are usually referred to as “momentum” based methods.

Once the edge (704) values have been updated, or altered from their initial values, through a backpropagation step, the neural network (700) will likely produce different outputs. Thus, the procedure of propagating at least one input through the neural network (700), comparing the neural network (700) output with the associated target with a loss function, computing the gradient of the loss function with respect to the edge (704) values, and updating the edge (704) values with a step guided by the gradient, is repeated until a termination criterion is reached. Common termination criteria are: reaching a fixed number of edge (704) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (704) values are no longer intended to be altered, the neural network (700) is said to be “trained.”

With respect to a CNN, it is useful to consider a structural grouping, or group, of weights. Such a group is herein referred to as a “filter.” The number of weights in a filter is typically much less than the number of inputs. In a CNN, the filters can be thought as “sliding” over, or convolving with, the inputs to form an intermediate output or intermediate representation of the inputs which still possesses a structural relationship. Like unto the neural network (700), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (700) to produce a final output. Note, that in this context, the neural network (700) is still considered part of the CNN. Like unto a neural network (700), a CNN is trained, after initialization of the filter weights, and the edge (704) values of the internal neural network (700), if present, with the backpropagation process in accordance with a loss function.

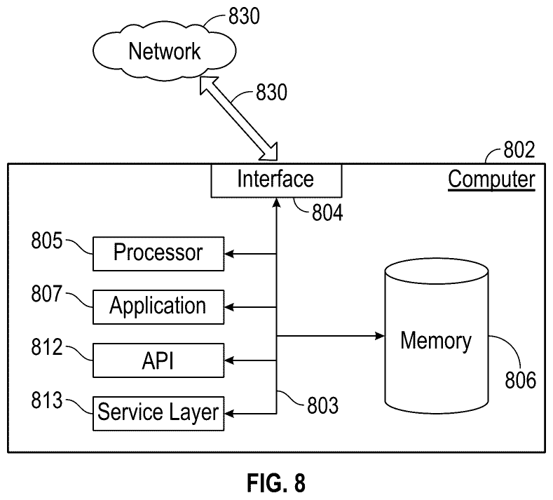

The computations mentioned in this disclosure may be performed by a computer, such as the first computer (JJJ69) in FIG. JJJ. In that regard, FIG. 8 depicts a block diagram of a computer (802) used to provide computational functionalities associated with described algorithms, methods, functions, processes, flows, and procedures as described in this disclosure, according to one or more embodiments. The illustrated computer (802) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (802) may include a computer that includes an input device, such as a keypad, keyboard, touch screen, or other device that can accept user information, and an output device that conveys information associated with the operation of the computer (802), including digital data, visual, or audio information (or a combination of information), or a GUI.

The computer (802) can serve in a role as a client, network component, a server, a database or other persistency, or any other component (or a combination of roles) of a computer system for performing the subject matter described in the instant disclosure. In some implementations, one or more components of the computer (802) may be configured to operate within environments, including cloud-computing-based, local, global, or other environments (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) can receive requests over network (830) from a client application (for example, executing on another computer (802) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) can communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer. Software services, such as those provided by the service layer (813), provide reusable, defined business functionalities through a defined interface. For example, the interface may be software written in JAVA, C++, or other suitable language providing data in extensible markup language (XML) format or another suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (804) includes logic encoded in software or hardware (or a combination of software and hardware) and operable to communicate with the network (830). More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single computer processor (805) in FIG. 8, two or more processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that can be connected to the network (830). The memory may be a non-transitory computer readable medium. For example, memory (806) can be a database storing data consistent with this disclosure. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) can be external to the computer (802).

The application (807) is an algorithmic software engine providing functionality according to particular needs, desires, or particular implementations of the computer (802), particularly with respect to functionality described in this disclosure. For example, application (807) can serve as one or more components, modules, applications, etc. Further, although illustrated as a single application (807), the application (807) may be implemented as multiple applications (807) on the computer (802). In addition, although illustrated as integral to the computer (802), in alternative implementations, the application (807) can be external to the computer (802).

There may be any number of computers such as the computer (802) associated with, or external to, a computer system containing computer (802), wherein each computer (802) communicates over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers such as the computer (802).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining a work summary for a work activity to be performed in a work environment;
determining, using an artificial intelligence (AI) model, a detailed work description based on the work summary, the detailed work description comprising one or more hazards associated with the work activity;
determining, using the AI model, a safety control to mitigate the one or more hazards;
implementing the safety control; and
performing the work activity according to the detailed work description and the safety control.

2. The method of claim 1, further comprising:
obtaining a safety regulation for the work activity;
obtaining safety data for the work activity, the safety data indicative of a state of the work activity;
making a safety determination, using the AI model based on the safety data, whether the work activity conforms to the safety regulation, and
applying a remediation in response to the safety determination that the work activity does not conform to the safety regulation.

3. The method of claim 2, wherein the safety data is obtained from one or more sensors installed in the work environment.

4. The method of claim 1, further comprising:
obtaining a safety regulation for the work activity;
making a preliminary safety determination, based on the detailed work description and the safety control, whether the work activity conforms to the safety regulation, and
issuing a work authorization in response to the preliminary safety determination that the work activity conforms to the safety regulation,
wherein the work activity is performed in response to issuing the work authorization.

5. The method of claim 4, further comprising:
obtaining safety data for the work activity, the safety data indicative of a state of the work activity;
making a safety determination, using the AI model based on the safety data, whether the work activity conforms to the safety regulation, and
applying a remediation in response to the safety determination that the work activity does not conform to the safety regulation.

6. The method of claim 4, further comprising obtaining preliminary safety data for the work activity, the preliminary safety data indicative of a state of the work activity;
wherein the preliminary safety determination is further based on the preliminary safety data.

7. The method of claim 1, further comprising:
making a work authorization determination, using the AI model, whether the work activity requires a work authorization, and
sending a work authorization request to an issuer in response to the work authorization determination that the work activity requires a work authorization.

8. The method of claim 2, wherein the remediation comprises either of:
a correction procedure, comprising:
halting the work activity;
updating the safety control as an updated safety control, based on the safety regulation, and
resuming the work activity in accordance with the updated safety control, or
a termination of the work activity.

9. The method of claim 1, wherein the AI model comprises a neural network.

10. The method of claim 3, wherein the one or more sensors comprise a camera.

11. A system, comprising:
a work environment;
a computer, comprising one or more computer processors, configured to:
receive a work summary for a work activity to be performed in the work environment;
determine, using an artificial intelligence (AI) model, a detailed work description based on the work summary, the detailed work description comprising one or more hazards associated with the work activity, and
determine, using the AI model, a safety control to mitigate the one or more hazards;
a safety control system, structured to:
receive the safety control from the computer, and
implement the safety control, and
a work entity, connected to the computer and the safety control system, the work entity structured to perform the work activity according to the detailed work description and the safety control.

12. The system of claim 11:
wherein the computer is further configured to:
receive a safety regulation for the work activity;
receive safety data for the work activity, and
determine, using the AI model, a safety state for the work activity, based on the safety data and the safety regulation, and
wherein the safety state is used by an issuer to perform steps, comprising:
making a safety determination whether the work activity conforms to the safety regulation, and
applying a remediation in response to the safety determination that the work activity does not conform to the safety regulation.

13. The system of claim 12, further comprising one or more sensors, installed in the work environment and connected to the computer, the one or more sensors configured to capture the safety data.

14. The system of claim 11:
wherein an issuer performs steps, comprising:
receiving the detailed work description from the computer;
obtaining a safety regulation;
making a preliminary safety determination, based on the detailed work description and the safety control, whether the work activity conforms to the safety regulation, and
issuing a work authorization in response to the preliminary safety determination that the work activity conforms to the safety regulation,
wherein the work activity is performed in response to issuing the work authorization.

15. The system of claim 14:
wherein the computer is further configured to:
receive safety data for the work activity and
determine, using the AI model, a safety state for the work activity, based on the safety data and the safety regulation, and
wherein the safety state is used by the issuer to perform steps, comprising:
making a safety determination, using the safety state, whether the work activity conforms to the safety regulation, and
applying a remediation in response to the safety determination that the work activity does not conform to the safety regulation.

16. The system of claim 14:
wherein the computer is further configured to:
receive the safety regulation,
receive preliminary safety data for the work activity, and
determine, using the AI model, a preliminary safety state for the work activity, based on the preliminary safety data and the safety regulation, and
wherein the preliminary safety determination is further based on the preliminary safety state.

17. The system of claim 11:
wherein the computer is further configured to make a work authorization determination, using the AI model, whether the work activity requires a work authorization, and
a requester performs steps, comprising sending a work authorization request to an issuer in response to the work authorization determination that the work activity requires a work authorization.

18. The system of claim 12, wherein the remediation comprises either of:
a correction procedure, comprising:
halting the work activity;
updating the safety control as an updated safety control, based on the safety regulation, and
resuming the work activity in accordance with the updated safety control, or
a termination of the work activity.

19. The system of claim 11, wherein the AI model comprises a neural network.

20. The system of claim 13, wherein the one or more sensors comprise a camera.
